(19) United States
(12) Patent Application Publication
(10) Pub. No.: US 2007/0290014 A1
(43) Pub. Date: Dec. 20, 2007

(54) Positioning System for Modules in a Vehicle

(75) Inventors: Matthew A. Kalis, Hudsonville, MI (US); Mark P. Kadzban, Grandville, MI (US); Kermit M. Anderson, Holland, MI (US); Bryan T. Jones, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company, Holland, MI (US)

(21) Appl. No.: 10/566,189

(22) PCT Filed: Jul. 20, 2004
(86) PCT No.: PCT/US04/23388

§ 371 Date: Jan. 27, 2006

Related U.S. Application Data
(60) Provisional application No. 60/491,339, filed on Jul. 30, 2003.

(51) Int. Cl. B62J 11/00

(52) U.S. Cl. 224/445; 224/400

(57) ABSTRACT

A positioning system for coupling a module to a rail member on an interior portion of a vehicle is disclosed and includes a rail with a flange member having positioning openings. The module includes at least one projection configured to engage the openings when the module is attached to the rail system so that movement of the module in a direction parallel to the rail system is substantially prevented. A positioning system is also disclosed for limiting movement of a module attached to a rail system within a vehicle interior during changes in vehicle speed or direction. The module includes at least one brake member coupled to the module and configured to coact with a rail so that movement of the module relative to the rail causes the brake member to frictionally engage the rail to substantially limit movement of the module along the rail.

### CROSS REFERENCE TO RELATED APPLICATIONS

The present Application claims the benefit of priority, as available under 35 U.S.C. § 119(e)(1) to U.S. Provisional Patent Application No. 60/491,339 titled “Positioning System For Modules In A Vehicle” filed on Jul. 30, 2003 (which is incorporated by reference in its entirety).

The following U.S. Patent is hereby incorporated by reference: U.S. Pat. No. 6,669,260 titled “Modular System for a Vehicle” filed May 1, 2001 and issued on Dec. 30, 2003.

### FIELD

The present invention relates to a positioning system for modules for a vehicle. The present invention relates more particularly to a system for positioning modules for use on a rail system in a vehicle. The present invention relates more particularly to a system for positioning modules on an overhead system for a vehicle to prevent sliding of the modules.

### BACKGROUND

Placement of modules on a rail system for use in an overhead location or other location of a vehicle are generally known and may include one or more modules such as storage compartments, bins, instrumentation, entertainment devices and the like. Such modules are typically attached to the rail system in a removable or interchangeable manner, such as to facilitate a customized package of module options available for consumers, promoting replacement or substitution of modules (e.g. by vehicle dealers or by consumers on an after-market basis, etc.), and permitting certain modules to be removed by consumers for uses that are external to the vehicle.

Such modules typically include attachment systems having a clip or clamping device intended to secure the modules to the rails in a manner that prevents movement in a vertical direction. However, such typical clips or clamping devices generally do not restrain movement of the modules in a horizontal direction along the length of the rails, particularly during rapid changes in acceleration or deceleration (such as braking, collisions, etc). Other attachment systems for modules may attempt to restrain movement of a module in all directions by the use of threaded fasteners or the like. However, such attachment systems tend to make replacement or interchanging modules more difficult and/or more time consuming.

Accordingly, it would be advantageous to provide a positioning system for modules on a rail system that provides secure retention of the module along the rails to prevent “sliding” or other undesirable movement. It would also be advantageous to provide a positioning system for modules on a rail system that permits the modules to be easily and conveniently removed or replaced. It would be further advantageous to provide a positioning system for modules that is configured for concealment within or behind the module to enhance the aesthetic appearance of the module.

Accordingly, it would be advantageous to provide a positioning system for a module having any one or more of these or other advantageous features.

### SUMMARY

The present invention relates to a positioning system intended to substantially prevent movement of a module along a rail system within a vehicle when the module is attached to the rail system. The rail system includes a flange member (e.g. anti-sliding flange, etc.) having a series of positioning openings. The module includes at least one projection configured to engage the openings when the module is attached to the rail system so that movement of the module in a direction parallel to the rail system is substantially prevented.

The present invention also relates to a positioning system for securing the placement of a module on at least one rail of a rail system within a vehicle interior. The rail includes a side portion having a series of openings. The module includes a bracket member configured for movement in a horizontal direction generally perpendicular to the rail (e.g. “y-axis” anti-sliding device) and having at least one projection configured to engage the openings when the module is attached to the rail system and the bracket is moved to a latched position so that movement of the module in a direction generally parallel to the rail system is substantially prevented.

The present invention further relates to a positioning system for limiting movement of a module attached to at least one rail of a rail system within a vehicle interior during rapid changes in vehicle speed or direction. The module includes at least one brake member (e.g. cam anti-sliding device) coupled to the module and configured to coact with the rail so that movement of the module relative to the rail causes the brake member to frictionally engage the rail to substantially prevent movement of the module along the rail.

### BRIEF DESCRIPTION OF THE DRAWINGS

FIG. 1A is a schematic representation of a front perspective view of a rail system and exemplary modules for a vehicle according to an embodiment.

FIG. 1B is a schematic representation of a back perspective view of the rail system and exemplary modules for a vehicle according to the embodiment of FIG. 1A.

FIG. 2A is a schematic representation of a perspective view of a rail member according to an exemplary embodiment.

FIG. 2B is a schematic representation of a perspective view of a rail member according to another exemplary embodiment.

FIG. 2C is a schematic representation of a perspective view of a rail member according to a further exemplary embodiment.

FIG. 2D is a schematic representation of a top view of a rail member according to a further exemplary embodiment.

FIG. 2E is a schematic representation of across sectional view of the rail member of FIG. 2D according to an exemplary embodiment.

FIG. 3A is a schematic representation of an end view of a rail system and a portion of a module according to an exemplary embodiment.

FIG. 3B is a schematic representation of a partial end view of a rail system and a portion of the module according to the embodiment of FIG. 3A.

FIG. 3C is a schematic representation of a partial side view of a rail system and module according to an exemplary embodiment.

FIG. 4A is a schematic representation of a perspective view of a positioning system for a module according to an exemplary embodiment.

FIG. 4B is a schematic representation of a reverse perspective view of a portion of the positioning system for a module according to the embodiment of FIG. 4A.

FIG. 4C is a schematic representation of a reverse perspective view of a portion of the positioning system for a module according to the embodiment of FIG. 4A.

FIG. 5A is a schematic representation of a back perspective view of a positioning system for a module according to an embodiment.

FIG. 5B is a schematic representation of a back view of the positioning system for a module according to the embodiment of FIG. 5A.

FIG. 5C is a schematic representation of a back perspective view of a portion of the positioning system for a module according to another embodiment.

FIG. 6 is a schematic representation of a top view of a portion of a positioning system for a module according to another embodiment.

### DETAILED DESCRIPTION

The positioning system for a module is shown and described for modules configured to attach to a rail system provided on an overhead portion of a vehicle (shown schematically as positioned on an “A” surface of a “headliner” or panel 12) such as shown and described in U.S. Pat. No. 6,669,260 titled “Modular System for a Vehicle” filed May 1, 2001 and issued on Dec. 30, 2003, the disclosure of which is incorporated by reference herein. However, the description of the various embodiments of the positioning system for a module are equally applicable to positioning systems for use with modules and rail systems in other locations within a vehicle, such a floor areas, cargo storage areas, seat backs, side panels, etc.

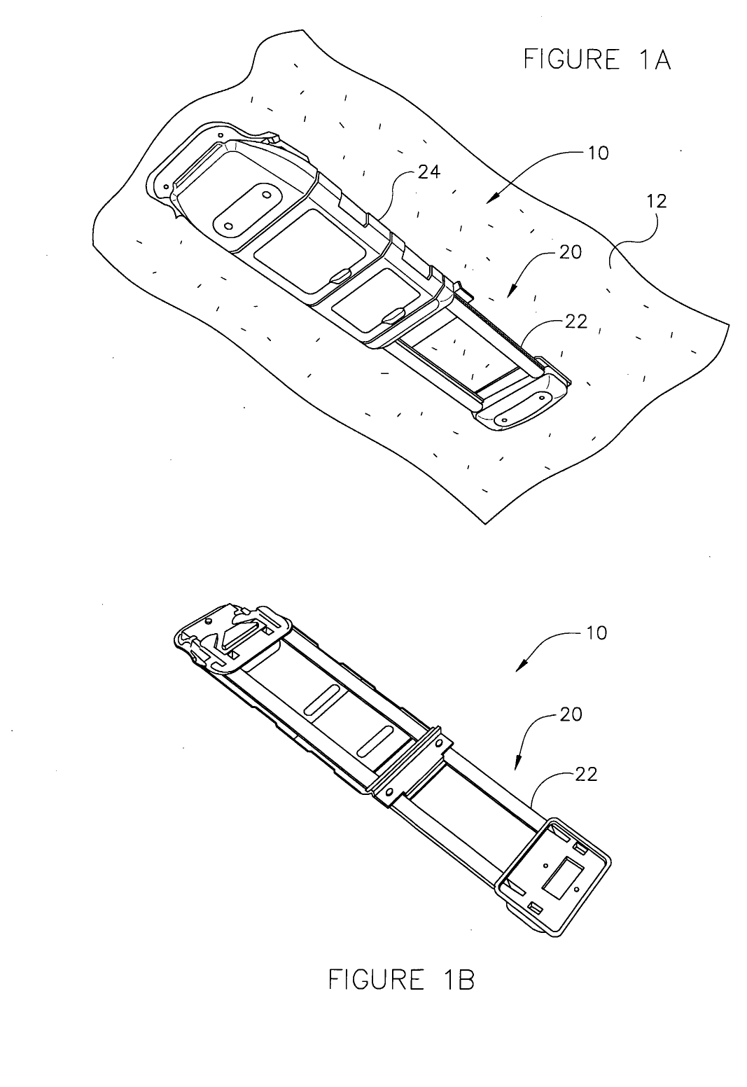

Referring to FIGS. 1A and 1B, an overhead system 10 for a vehicle is shown according to one embodiment. Overhead system 10 includes a rail system 20 having at least one rail member 22 (shown schematically as two rails or tracks) and a plurality of modules 24 (e.g. articles, products, devices, etc.) configured for attachment to the rails 22 of the rail system 20. Modules 24 may be attached to the rails 22 by a suitable attachment system, such as clips, holders, latches, catches, etc. (not shown). The rails may be secured directly to structural components of the vehicle such as roof headers, cross bows, pillars, etc. or may be secured via clips or fasteners to brackets that are positioned behind a headliner or other panel within the vehicle.

The modules may be positioned at any desired location or spacing along the rail system that is desired by the user of the vehicle. In the event that a space exists between adjacent modules, or between a module and an end of the rail system, the positioning system for the modules is intended to prevent substantial movement of the modules along the rails during rapid changes in the speed or direction of a vehicle, during which the modules may otherwise tend to move or shift.

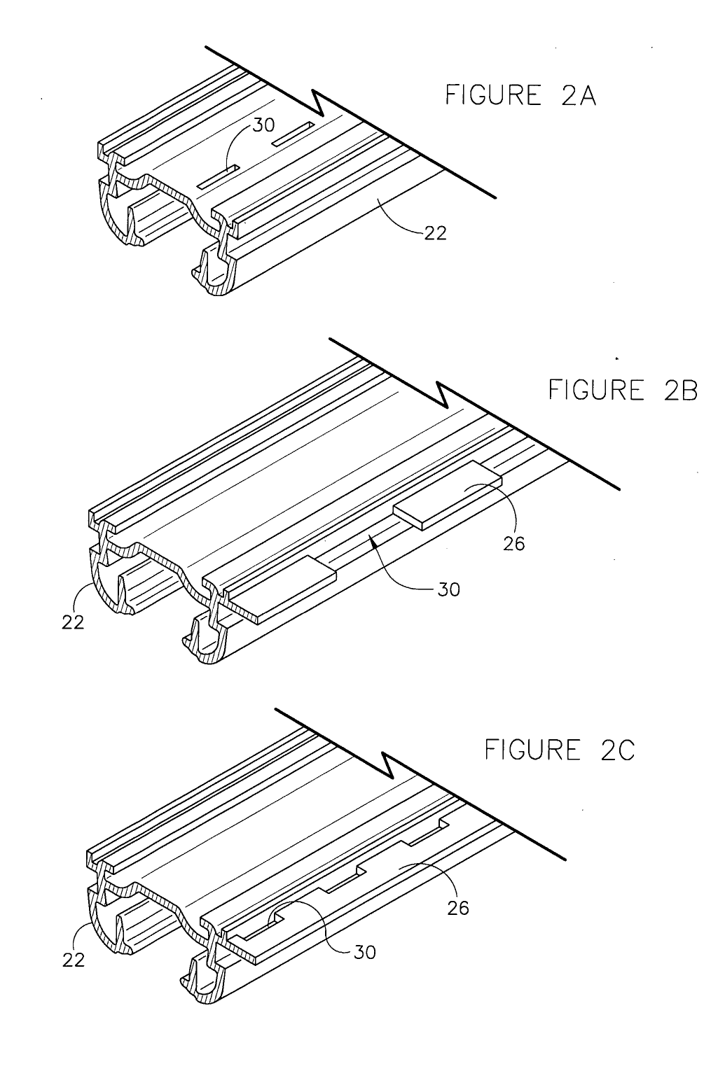

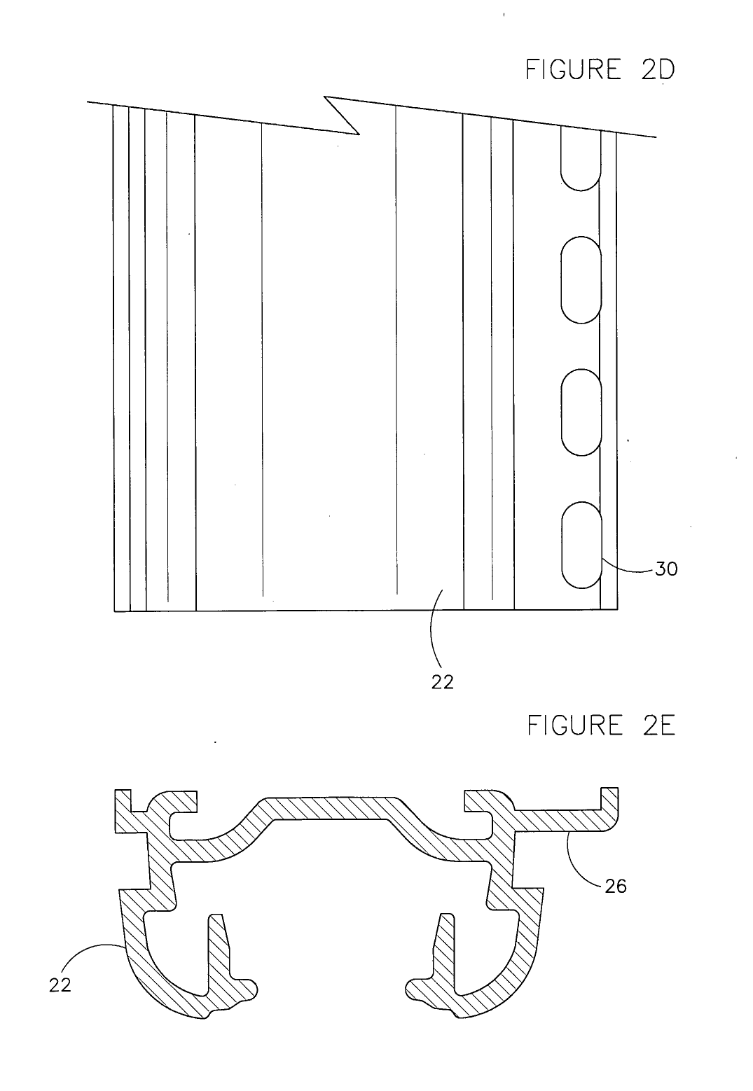

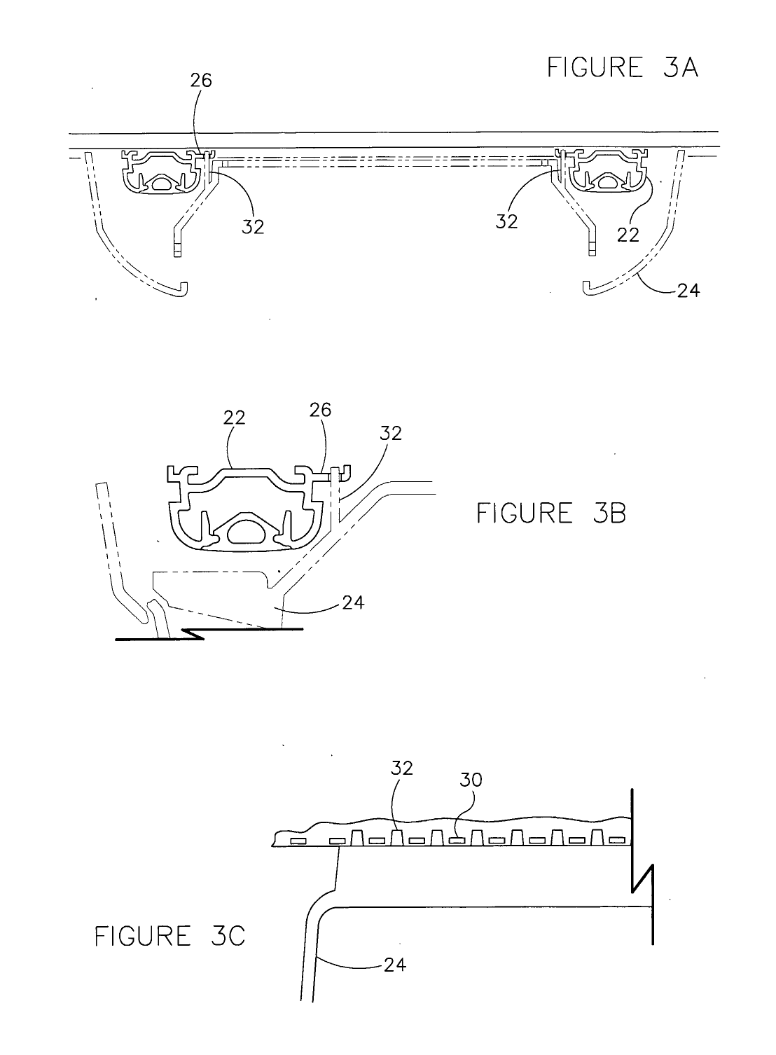

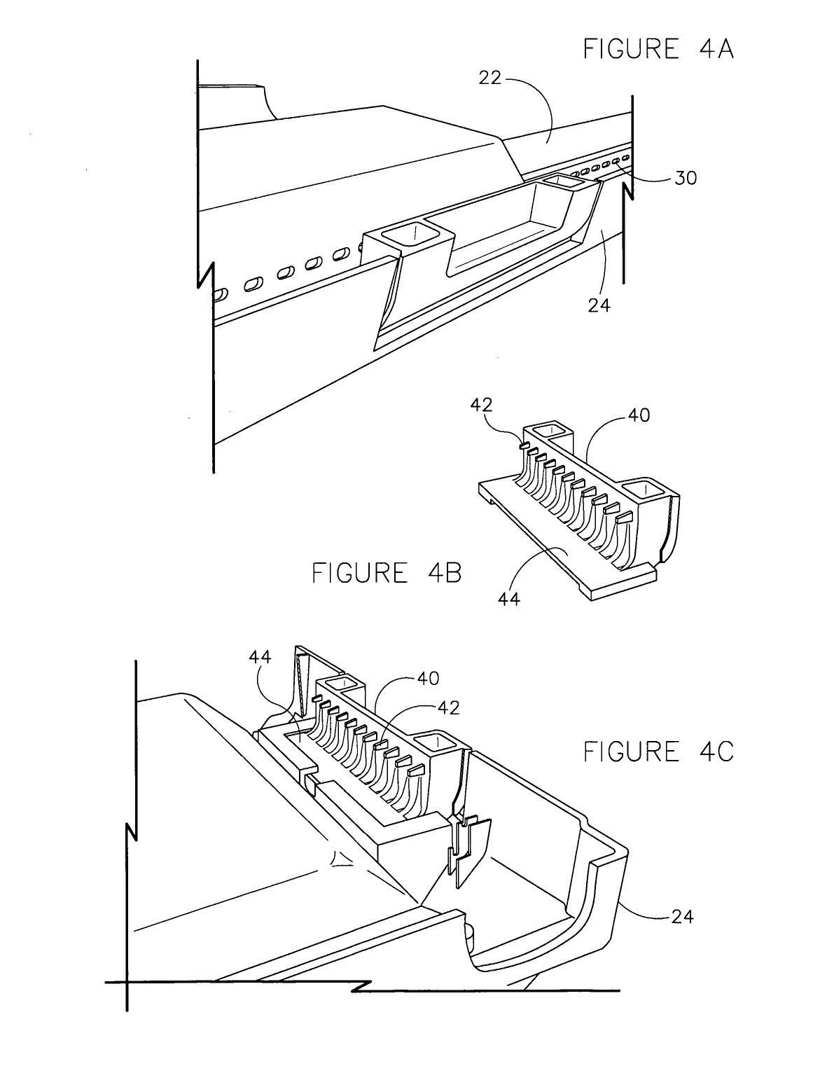

Referring to one embodiment shown in FIGS. 2A-2E, the rails 22 of the rail system are provided with a plurality or series of openings 30 (e.g. notches, apertures, slots, holes, etc.). The openings may be provided along a flange member 26 (e.g. shelf, ledge, etc., shown for example as an inwardly extending flange member), or along a portion of the rail member such as a top surface (as shown schematically in FIG. 2A) or along a side wall of the rail (shown for example in FIG. 4A). The flanges may be oriented on an inward side of the rails (as shown for example in FIG. 3A) or the flanges may be oriented on an outward side of the rails (not shown). The openings may be formed, for example, as oval slots, rectangular slots, etc. or may be formed as notches that create projections (shown schematically as “teeth” in FIG. 2B with a flange extending approximately 4 millimeters (mm) according to an exemplary embodiment). The openings may be provided in any suitable shape, size, spacing or location on the rail member in order to coact with corresponding projection(s) provided in or on the modules. According to one preferred embodiment, the rails are made of aluminum in an extrusion process and have a height of approximately 22 mm and a width of approximately 46 mm, and the openings have dimensions of approximately 20 mm by 3 mm, with a spacing of 20 mm between the openings. Where a flange member is provided, the flange member may have an upwardly extending edge (as shown schematically in FIGS. 2E and 3B). According to another preferred embodiment, the openings have dimensions of approximately 6 mm by 3 mm. According to alternative embodiments, the openings may have a particular shape, size or spacing at one location along the rail, and a different shape, size or spacing along another section of the rail to function as an “interlock” so that certain modules are capable of installation or attachment only on portions of the rail that have openings corresponding to the pattern of projections (to be further described) provided in the module. Such an interlock is intended to permit only certain types of modules to be installed at certain predetermined locations along the rails (e.g. display screens or entertainment devices may be installed only at a location rearward of the front seats of the vehicle, etc.).

The openings 30 on the rail member 22 are intended to coact with corresponding projections 32 or members (shown schematically for example as a series of “teeth” in FIGS. 3A-3C) on the modules 24 when the modules are attached to the rails. Referring to FIGS. 3A through 3C a positioning system is shown according to an embodiment. Module 24 is shown having a plurality of projections 32 (shown schematically as projections extending in a generally vertical direction) that are configured to engage openings 30 in the rails in a coacting relationship (e.g. joined, intertwined, intermeshed, dovetailed, etc.). The projections may be provided as multiple projections (as shown in FIG. 3C), or may be provided as a single projection. The projections may extend from opposite sides of the module and configured to engage each rail in a rail system having two rails, or the projections may be provided on a single side of the module for engagement with only one rail. According to a preferred embodiment, the projections are formed integrally with the module and made from a plastic or polymer material in a molding operation. The projections may be shaped having a profile with sides that are “slanted” or angled (as shown schematically in FIG. 3C) that is intended to facilitate entry of the projections into the opening. According to a particularly preferred embodiment, the sides of the projections have an angle of approximately 5 degrees from vertical. According to alternative embodiments, the orientation of the openings on the rails and the projections on the modules may be changed. For example, the openings on the rails may be provided in a generally vertical plane and the projections on the modules may be provided in a generally horizontal plane and configured to engage the openings. Further, the sides of the projections may have any suitable angle or may have other shapes (e.g. rounded, etc.) as desired to facilitate engagement with the openings.

Referring to FIGS. 4A through 4C, a positioning system is shown according to another embodiment. Module 24 is shown to include an attachment bracket 40 that is movable between a released position (not shown) and an engaged position (as shown in FIGS. 4A and 4C). Bracket 40 is shown having a series of projections 42 (e.g. teeth, nubs, prongs, etc.) configured to engage the openings 30 in rail 22 when the bracket is moved into the engaged position. According to a preferred embodiment, bracket 40 is made from a plastic material in a molding operation and includes an integrally formed slide portion 44 configured to slide in a generally horizontal plane generally perpendicular to the rails for releasable engagement of horizontally extending projections 42 within side openings 30 in rail 22 that are shown oriented in a generally vertical plane. The projections may have any suitable shape and size (such as previously described in reference to FIG. 3C), and provided in any suitable number to facilitate engagement with openings 30. A spring (not shown) may be provided to bias the bracket in a direction (e.g. horizontally inward, etc.) toward the engaged position, so that for removal of the module from the rail system, a user would slide the bracket from the engaged position to the released position against the spring force. The positioning system may include a single bracket (as shown) or may include two brackets (e.g. one each on opposite sides of the module) for engagement with each rail in a two-rail system. According to alternative embodiments, the projections provided in the bracket may be provided in any suitable shape, size or location to correspond with the openings provided in the rail member. The projections may also be configured to provide an “interlock” as previously described for limiting the placement of the module on the rail system to certain predetermined locations. According to any preferred embodiment, the attachment bracket is configured to restrain movement of the modules in a vertical direction (e.g. perpendicular to a headliner panel) and in a horizontal direction (e.g. fore and aft along the rails and side-to-side with respect to the rails).

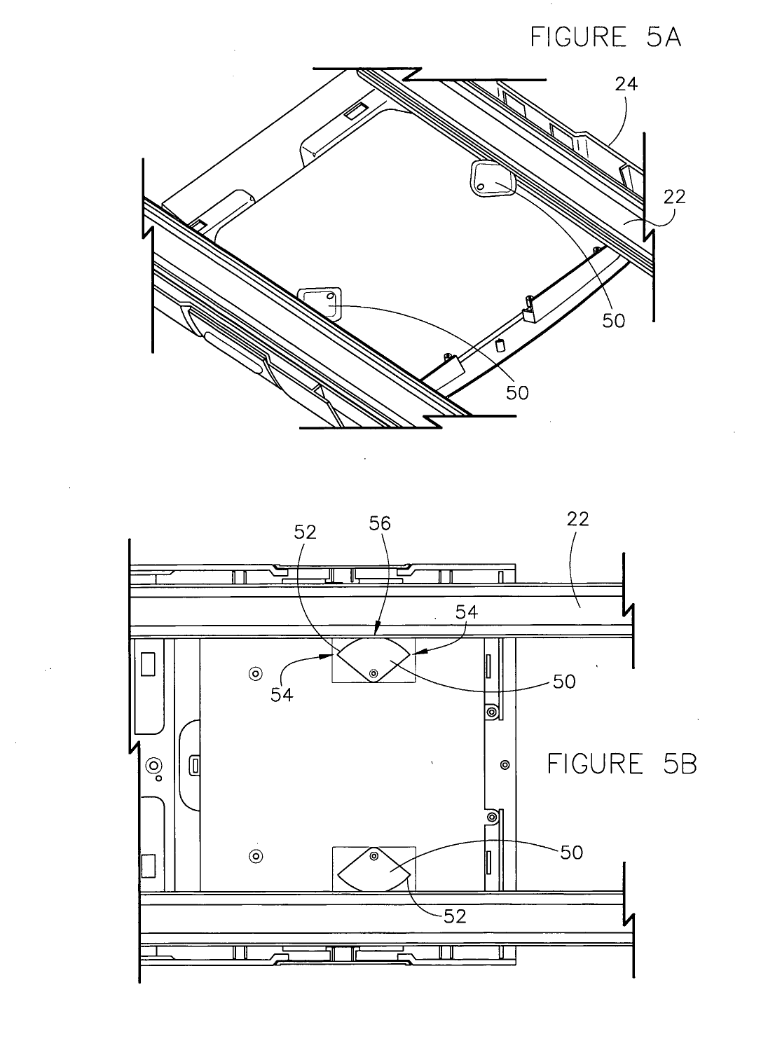

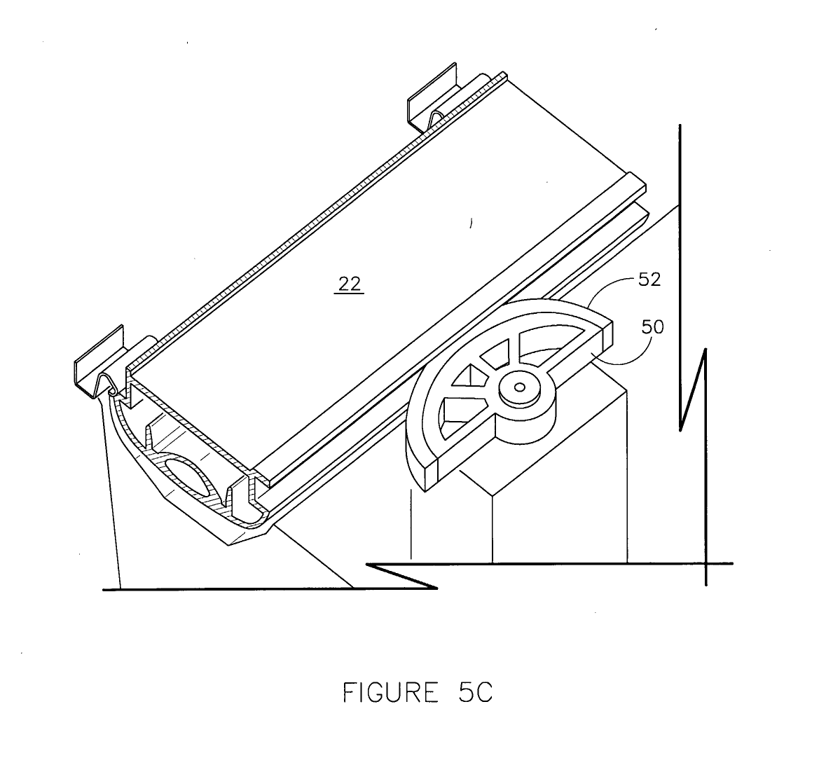

Referring to FIGS. 5A through 5C, a positioning system for a module on a vehicle is shown according to another embodiment. Module 24 is shown having a top surface adjacent the rails that includes a brake member 50. Brake member 50 is shown pivotally coupled to the top of module 24 and includes a curved outward surface 52 (e.g. cam profile, etc.) configured to interact with the rail 22 as a frictional cam brake. According to a preferred embodiment, the curved outward surface of brake member 50 is shaped so that the radius of curvature at the ends 54 of the cam profile is greater than the radius of curvature at the middle 56 of the cam profile. Brake member 50 is pivotally joined to the module (e.g. by pins, bushings, screws, heat stake, etc.—not shown) so that the center of the cam profile of the brake member contacts an inside surface of the rail. According to a preferred embodiment, brake member 50 is made from a generally rigid material (e.g. aluminum, plastic, etc.) and the surface of the cam profile is made of an elastic-type material having a “gripping” texture or a generally high frictional coefficient (e.g. rubber, etc.) that provides a frictional interface between the cam profile and the rail. As movement of the module may tend to occur due to changes in the speed or direction of the vehicle, the brake member tends to pivot in either direction and the increasing radius of the cam profile tends to result in a greater friction force to create a “wedging” action between the brake members and the rails and is intended to resist movement of the module relative to the rails. The specific shape of the cam profile may be varied according to the mass of the module, expected acceleration and deceleration, tolerances within the rail system and the overhead system, and potential deflection of the rails during actuation of brakes on multiple modules on the rail system. According to a preferred embodiment, the module is provided with two brake members (i.e. one each positioned on opposite sides of the top of the module) and configured to interact with an inside surface of the rails to maximize the effectiveness of the frictional braking action.

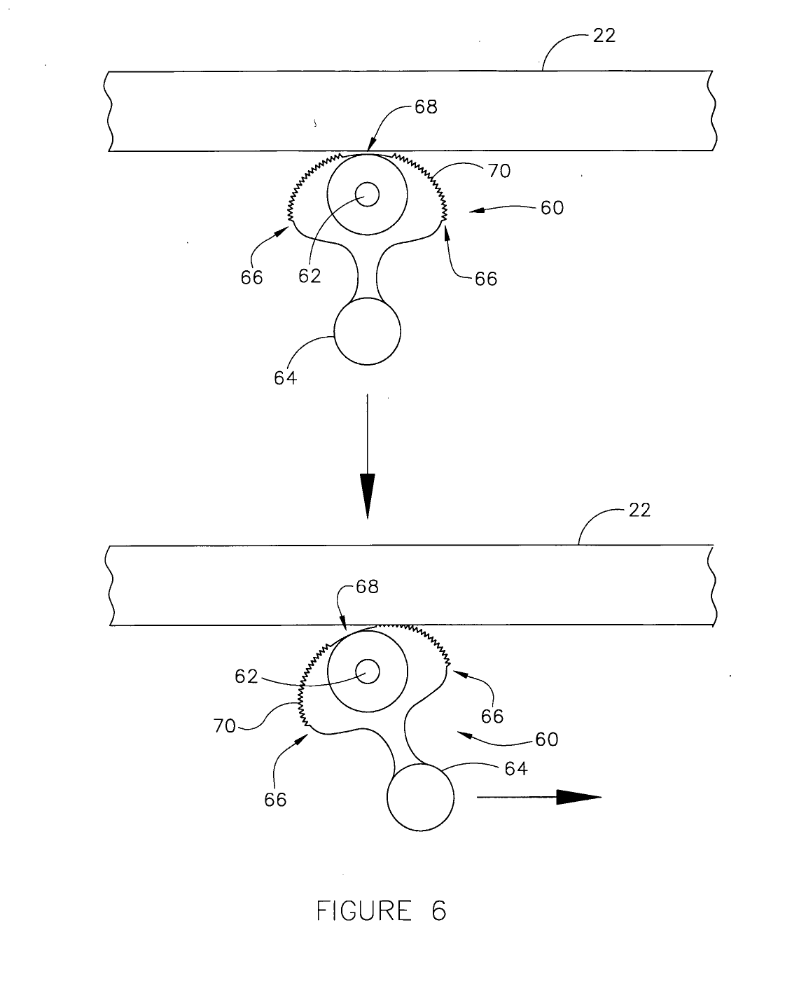

Referring to FIG. 6, a positioning system for a module is shown according to another embodiment. Module 24 has a top surface or side surface adjacent to the rails that includes a brake member 60. Brake member 60 is shown pivotally coupled to the module 24 at a pivot point 62 and includes a curved outward surface (e.g. cam profile, etc.) configured to interact with the rail as a frictional cam brake. Brake member 60 is also shown to include an eccentric mass member 64 extending inwardly (i.e. on an opposite side of the pivot point from the associated rail member). Brake member 60 is shaped so that the radius of curvature at the ends 66 of the cam profile is greater than the radius of curvature at the center (e.g. middle) 68 of the cam profile. Brake member 60 is pivotally joined to the module at pivot point 62 (e.g. by pins, bushings, screws, etc.—not shown) so that the center 68 of the cam profile of the brake member is in contact with an inside surface of the rail. According to a preferred embodiment, brake member 60 is made from a generally rigid material (e.g. steel, aluminum, plastic, etc.) and the surface of the cam profile is provided with a “gripping” or “textured” surface (e.g. shown as teeth 70, or serrations, knurls, etc.) that tend to “grip” or “bite” a surface of the rail member. As movement of the module tends to occur due to changes in the speed or direction of the vehicle, the eccentric mass member tends to pivot the brake member in either direction and the increasing radius of the cam profile tends to result in a greater friction force between the cam profile to create a “wedging” type interaction between the brakes and the rail to resist movement of the module relative to the rails. The specific shape of the cam profile may be varied according to the mass of the module, expected acceleration and deceleration, tolerances within the rail system and the overhead system, and potential deflection of the rails during actuation of brakes on multiple modules on the rail system. According to a preferred embodiment, the module is provided with two brake members (i.e. one each positioned on opposite sides of the top or sides of the module) and configured to interact with a surface of the rails to maximize the effectiveness of the wedging interaction and the frictional braking action.

According to any preferred embodiment, the positioning system is intended to cooperate with an attachment system for a module that is easily and conveniently accessible and operable by a wide variety of users to remove, replace, reposition, and/or install one or more modules within a vehicle, such as within or in connection with, an overhead system for a vehicle having one or more elongated members such as rails. The components of the various embodiments of the positioning system are intended to provide a lightweight, rugged, reliable and durable structure for attaching the modules to the rails (or other structure) within the vehicle. The components may be made of any suitable material such as plastic (e.g. ABS plastic, etc.), metal (e.g. aluminum, steel, etc.) or other materials that provide the desired strength to retain the position of the modules on the rails during all appropriate loading conditions and scenarios.

It is important to note that the construction and arrangement of the elements of the various embodiments of the positioning system provided herein is illustrative only. Although only a few exemplary embodiments of the present inventions have been described in detail in this disclosure, those skilled in the art who review this disclosure will readily appreciate that many modifications are possible in these embodiments (such as variations in rail configurations, shape and size of the openings and projections, frictional materials, mounting arrangements, use of colors, combinations of shapes, etc.) without materially departing from the novel teachings and advantages of the inventions. Also, positioning of the modules may be accomplished by interconnecting adjacent modules to one another through suitable interconnecting structure (e.g. “training” of the modules). Such training may be accomplished through “latches” or “catches” or other suitable structure configured for coupling abutting ends or sides of adjacent modules. Further, the positioning system may be used in any type of vehicle such as trucks, recreational vehicles, minivans, sport utility vehicles, passenger automobiles, etc. and at any suitable location within the vehicle (such as floors, cargo storage areas, etc.). Accordingly, all such modifications are intended to be within the scope of the invention as defined in the appended claims.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

1. A positioning system for modules coupled to at least one rail member in a vehicle, comprising;
a plurality of openings provided on the rail member;
the module having a housing defining a storage compartment;
at least one projection extending from the module and configured to engage at least one of the plurality of openings;
so that engagement of the at least one projection and the at least one of the plurality of openings substantially prevents movement of the module in at least one direction.

2. The positioning system of claim 1 wherein the projection extends in a substantially vertical direction.

3. The positioning system of claim 1 wherein the projection extends in a substantially horizontal direction.

4. The positioning system of claim 1 wherein the plurality of openings are provided in a flange member extending from the rail member.

5. The positioning system of claim 1 wherein the projections are tapered.

6. The positioning system of claim 1 wherein the projections are configured for interchangeably positioning the modules at various locations along the rail member.

7. The positioning system of claim 1 wherein the projections are configured to substantially restrict movement of the modules relative to a longitudinal axis of the rail member.

8. The positioning system of claim 1 wherein the projections are integrally formed with the module.

9. The positioning system of claim 1 wherein the projections are substantially concealed from an occupant of the vehicle when the module is coupled to the rail member.

10. A positioning device for a module having an entertainment device adapted for coupling to a rail system in an interior space of a vehicle, comprising a bracket that is movable between a first position where the movement of the entertainment device relative to the rail system is substantially restricted and a second position where movement of the entertainment device relative to the rail system is permitted.

11. The positioning device of claim 10 wherein the bracket is configured to slide in a generally horizontal direction between the first position and the second position.

12. The positioning device of claim 10 wherein the first position is an engaged position and the second position is a released position.

13. The positioning device of claim 10 wherein the bracket includes at least one projection extending from the bracket.

14. The positioning device of claim 10 wherein the projection is configured to engage at least one opening in a rail member of the rail system when the bracket is in the engaged position.

15. The positioning device of claim 10 wherein the bracket is biased into the engaged position.

16. The positioning device of claim 10 further comprising an interlock formed from two or more patterns of openings in a rail member of the rail system that are configured to permit the projections to engage the openings only in predetermined locations along the rail member.

17. A positioning mechanism for a module configured for attachment to a rail system within a vehicle, comprising at least one rail member attached to an interior of the vehicle and configured to receive the module and at least one brake member pivotally attached to the module and having a surface configured to contact the rail member to substantially limit movement of the module along an axis of the rail member.

18. The positioning mechanism of claim 17 wherein the brake member actuates to engage the rail member in a wedging interaction when the module moves relative to the rail member.

19. The positioning mechanism of claim 17 wherein the surface of the brake member includes a cam profile configured to develop a frictional interaction with the rail member when the module is moved relative to the rail member.

20. The positioning mechanism of claim 17 wherein the brake member is an inertial brake member.

21. The positioning mechanism of claim 19 wherein the cam profile includes a face portion having a gripping surface.

22. The positioning mechanism of claim 21 wherein the gripping surface includes a plurality of teeth.

23. The positioning mechanism of claim 21 wherein the gripping surface comprises a textured material.

24. The positioning mechanism of claim 17 wherein the brake member further comprises a counterweight.

25. An anti-slide device for limiting movement of modules along at least one rail member of a rail system positioned within an interior of a vehicle, comprising a brake member having a first portion pivotally coupled to the module and a second portion configured for frictional engagement with the rail member so that when the module tends to move, the brake member creates a wedging interaction between the module and the rail member to substantially limit further movement of the module along the rail member.

26. The anti-slide device of claim 25 wherein the second portion comprises a curved surface.

27. The anti-slide device of claim 26 wherein the curved surface is non-circular and creates an increasing wedging interaction as a force on module increases.

28. The anti-slide device of claim 25 wherein the second portion further comprises a gripping surface.

29. The anti-slide device of claim 28 wherein the gripping surface comprises a textured material.

30. The anti-slide device of claim 28 wherein the gripping material comprises teeth.
